(19) United States
(12) Patent Application Publication
(10) Pub. No.: US 2012/0074342 A1
(43) Pub. Date: Mar. 29, 2012

(54) COATINGS, THEIR PRODUCTION AND USE

(75) Inventors: George Ea-Hwan Kim, Ile des Soeurs (CA); John Blaine Williams, JR., Houston, TX (US)

(73) Assignee: Scientific Valve and Seal, L.P., Houston, TX (US)

(21) Appl. No.: 13/093,087

(22) Filed: Apr. 25, 2011

Related U.S. Application Data
(63) Continuation of application No. 12/022,749, filed on Jan. 30, 2008, now abandoned.
(60) Provisional application No. 60/887,453, filed on Jan. 31, 2007.

(51) Int. Cl. F16K 5/06; B32B 3/00; B32B 15/04

(52) U.S. Cl. 251/315.01; 428/469; 428/336

(57) ABSTRACT

Disclosed herein are agglomerate blends suitable for application to a surface of a substrate by thermal spray, thereby to produce coatings, typically nanostructured coatings, that exhibit desirable properties such as erosion, abrasion, or corrosion resistance. Such coatings have many useful applications, including but not limited to an enhancement of valve reliability and durability. For example, the nanostructured coatings may be applied to valve components (i.e., balls and seats) via thermal spray processes, wherein the feedstock powder used in thermal spray may be composed, for example, of a chromium oxide composite material that meets the protective requirements against the wear and corrosion of the valve service. The thermal spray process may involve, but is not limited to, either a plasma spray or high-velocity combustion process. Through their enhanced properties, the coatings can provide superior reliability and extended life to components such as valves. Also disclosed are methods for producing the coatings, and correspondingly coated components.

### CROSS-REFERENCE TO RELATED APPLICATION

This application claims the priority right of prior U.S. patent application 60/887,453 filed Jan. 31, 2007 by applicants herein.

### FIELD OF THE INVENTION

The invention relates to coatings suitable for coating a component to improve the resistance of the component to some form of degradation or wear, such as abrasion, erosion, or corrosion. In particular, the invention relates to the field of nanostructured matrix composite coatings, as well as methods for their production and use.

### BACKGROUND TO THE INVENTION

Thermal spray technology typically involves the projection of molten or semi-molten particles of metals, ceramics, or their composites from powder or wire feedstock. Generally, any material which has a stable molten phase and can be processed into the appropriate feed specifications can be thermal sprayed. The melting may be achieved, for example, chemically via oxygen-fuel combustion or electrically via an arc.

The hot particles are accelerated by the combustion flame or the plasma jet onto a surface, forming a lamellar structure. Multiple passes may result in a buildup of lamellae layers to a desired thickness, often in excess of 50 micrometers. A typical thermal-sprayed single-component coating may consist of a fine grain structure, having properties associated with such a microstructure, as well as non-homogeneous features such as splat boundaries, pores, oxide inclusions, and un-melted particles. Even with the inherent microstructural non-homogeneity of thermal sprayed coatings, when applied correctly, they often lead to reproducible enhancements in protection of components against wear.

In 1997 Dr. Lawrence T. Kabacoff at the United States Office of Naval Research (ONR) began a five-year program entitled, “Thermal Spray Processing of Nanostructured Coatings” [1]. The work was based on the notion that properties of existing materials drastically change when physical features (Le., grain size, fiber diameter, layer thickness, particle diameter) of a material are reduced to and kept below 100 nm. ONR's overall objective was to reduce maintenance costs by extending the service life of ship components through the enhanced properties of nanostructured materials in coating form. The technical objective was to fabricate nanostructured coatings with extraordinary combinations of hardness, toughness, abrasion resistance, and adherence.

The findings from the ONR program have led to numerous successes in the use of nanostructured coatings for military applications. The work carried out by Gell et al. [2, 3] at the University of Connecticut (UCONN) on a nanostructured form of a commonly used wear-resistant coating material, alumina-titania, has yielded very unique properties. These properties include enhanced bond strength, superior wear resistance, and remarkable toughness.

In 2001, the first industrial application and a derivative of the ONR program was introduced for ball valve protection [4-6]. By incorporating the knowledge gained from the results of ONR's program and further optimizing the concept, a nanostructured titanium dioxide coating was developed and successfully introduced to target the severe-service industrial application associated with the extraction of gold, nickel, and cobalt from low grade ore. This is disclosed in U.S. Pat. No. 6,835,449 issued Dec. 28, 2004, which is incorporated herein by reference. This coating demonstrated substantial improvements in abrasive and erosive wear resistance while remaining inert to the autoclave conditions. Other examples of representative patents related to thermal spraying and coatings include: U.S. Pat. No. 5,874,134 issued Feb. 23, 1999; U.S. Pat. No. 5,939,146 issued Aug. 17, 1999; U.S. Pat. No. 6,723,387 issued Apr. 20, 2004; and U.S. Pat. No. 6,025,034 issued Feb. 15, 2000, all of which are incorporated herein by reference. In another example, International Patent Application PCT/US02/24600 (published as WO03/022741), which is also incorporated by reference, discloses nanostructured titania coatings and their use.

Therefore, coatings produced by thermal spray techniques have found particularly useful applications to enhance the durability of components exposed to higher levels of stress including but not limited to mechanically, thermally, or chemically abrasive, erosive, or corrosive conditions.

In one example of such components, valves are devices that regulate the flow of fluids in gaseous, fluidized solid, slurry, or liquid form by opening, closing, or partially obstructing various passageways. Valves are used in a variety of applications including industrial, military, commercial, residential, and transportation. Depending on the specific application, components of a valve may require protection via the incorporation of coatings.

Examples of valves requiring coating protection are ball valves used in the high pressure acid leach (HPAL) process. The nickel/cobalt HPAL technology relies on very severe processing environment to economically leach and extract nickel and cobalt from low-grade ore. The current processing environment consists of very hot (>250 C) and corrosive (up to 98% sulfuric acid) slurry (20 wt % solids) at high pressures (4,700 to 5,500 kPa). The severe conditions found in Ni/Co HPAL require the ball valves to have protection against abrasive wear, erosive wear, thermal stress, and extreme corrosion. To extend the life of the ball valves while meeting the general mechanical requirements of the components, titanium and duplex stainless steel alloy balls and seats are treated with various surfacing techniques. Amongst the surfacing technologies available, thermal spray application of single- and multi-layer coatings is predominantly used.

Due to the high costs associated with maintaining valves in many autoclave mines (up to 35% of total expense in Ni/Co HPAL), any improvements in valve life and performance is greatly rewarded. Current specifications use top coats of chromia-blend, chromia composite, or monolithic titania applied via thermal spray onto metal balls and seats with or without a metallic bond coat.

However, in spite of significant advances in thermal spray techniques, and correspondingly produced coatings, there remains a continuing need for further improvements to such coatings, and their application. This need is, perhaps, most particularly prevalent when such coatings are applied to components used under high levels of thermal, chemical, or mechanical stress, such as for example HPAL processes.

### SUMMARY OF THE INVENTION

It is one object of the present invention, at least in preferred embodiments, to provide a coating suitable to improve the resistance to wear, abrasion, erosion, or corrosion, of a component to which the coating is applied.

It is another object of the present invention, at least in preferred embodiments, to provide a method of improving the resistance to wear, abrasion, erosion, or corrosion, of a component.

It is another object of the present invention, at least in preferred embodiments, to provide a component coated with a coating to improve the resistance of the component to wear, abrasion, erosion, or corrosion.

In one aspect of the invention there is provided a blend of spherical or substantially spherical agglomerates with reinforcement particles, each agglomerate having a size of from 5 to 100 microns, the blend comprising a major portion of chromia agglomerates and a minor portion of reinforcement particles immiscible with the chromia.

In another aspect of the invention there is provided a nanostructured chromia coating bonded directly on a titanium or duplex stainless steel substrate.

In another aspect of the invention there is provided a nanostructured chromia coating with a ground and polished surface on a titanium or duplex stainless steel substrate.

In another aspect of the invention there is provided a method for applying a nanostructured chromia coating to a surface of a substrate, the method comprising the steps of:
(a) preparing at least one blend each comprising a mixture of agglomerated nanoparticles of chromia and second-phase particles, wherein the second-phase particles, in agglomerate or solid form, are immiscible with chromia, corrosion resistant and comprise a minor proportion of each blend by total volume of the particles;
(b) thermally spraying the at least one blend onto said surface of said substrate to deposit a coating of nanostructured chromia thereupon;
(c) optionally grinding and polishing the coating.

In another aspect of the invention there is provided a ball valve for use in a pressure leaching process wherein the ball valve is exposed to corrosive fluids and/or abrasive solid particles, the ball valve comprising:
a valve body;
a ball centrally positioned in the valve body and having a central passage rotatable in the valve body between open and closed positions;
at least one seat disposed between the ball and the valve body;
wherein the ball and seat each comprise a metal substrate titanium or duplex stainless steel or other metals selected for corrosion or strength (such as but not limited to tantalum, or Inconel 600), the metal substrate having a nanostructured chromia coating.

In another aspect of the invention there is provided a pressure acid leaching process comprising alternately opening and closing the ball valve of the present invention to respectively allow and stop passage of an acid leach mixture comprising abrasive particles in a solution of at least 98 percent sulfuric acid at a temperature above 250° C. and pressure above 4000 kPa.

In another aspect of the invention there is provided an apparatus for applying a nanostructured chromia coating, comprising:
means for preparing blended feedstock powder comprising of agglomerates of chromia nanoparticles and agglomerated or solid second-phase particles, wherein the agglomerated or solid second-phase particles are immiscible with the chromia, corrosion resistant, and comprise a minor proportion of the feedstock powder;
a reservoir comprising a charge of the feedstock powder;
means for thermally spraying the feedstock powder from the reservoir onto a substrate surface to deposit a coating of nanostructured chromia thereon.

Other aspects of the invention will become apparent from a reading of the present specification in its entirety.

### BRIEF DESCRIPTION OF THE DRAWINGS

FIG. 1 schematically illustrates an agglomerated nanostructured composite powder, and its application via thermal spray to a substrate to form a coating.

FIG. 2 is a cross-sectional view of a ball valve according to one embodiment of the invention.

FIG. 3 is an enlarged view of the section of the ball valve appearing in circle 3 of FIG. 2.

FIG. 4 is an enlarged view of the section of the ball valve appearing in circle 4 of FIG. 2.

FIG. 5 is an enlarged view of the section of the ball valve appearing in oval 5 of FIG. 2.

FIG. 6 shows electron microscope images of a nanostructured chromia matrix coating of the present invention deposited onto a substrate by thermal spray (Sample 50499-10), at a) 100× magnification, b) 200× magnification, and c) 400× magnification.

### DEFINITIONS

Coating: refers to any coating applied to a substrate.
Thermal Spray: refers broadly to a technique that involves heat softening and/or melting of a material (metal, ceramic, polymer, or their composites) in powder or wire form and accelerating the droplets/particles onto a substrate, where upon impact, forms a coating.
Component: any item or article onto which a coating is applied in accordance with the present invention. Such a component may also be referred to as a substrate, with a surface of the substrate being the surface onto which the coating is deposited. The component may comprise any material, but more preferably comprises a metal or metal alloy, for example comprising Aluminum, magnesium, Zinc, steel, duplex stainless steel, or titanium.
Substrate: refers to at least a portion of a component or other mass having a surface to which a coating can be applied.
Preferably: unless otherwise stated, the term preferably refers to preferred features of the broadest embodiments of the invention.

### DETAILED DESCRIPTION OF THE PREFERRED EMBODIMENTS

The present invention is directed, at least in preferred embodiments, to coatings such as nanostructured chromia matrix coatings, reinforced with ceramic phases to provide enhanced properties. These coatings can be prepared by thermal spray coating nanostructured chromia agglomerates blended with the reinforced particles onto a substrate surface. In preferred embodiments of the invention, the abovementioned and other deficiencies of the prior art are overcome or alleviated by the resultant coatings of the present invention, which will enhance the reliability and the life of components to which they are applied (e.g. ball valves) by incorporating superior coatings with a nanostructured chromia matrix reinforced with ceramic particles.

In one preferred embodiment, the present invention provides for a blend of spherical or at least substantially spherical chromia agglomerates mixed with angular, equi-axed or at least substantially spherical, agglomerated reinforcement particles useful in thermal spray coating. The agglomerates and the reinforcement particles preferably have a size range of from 5 to 100 microns, more preferably 10 to 45 microns. The agglomerates preferably comprise a mixture of chromia nano-particles of less than 0.1 microns. The reinforcement particles preferably constitute from 5 to 49 volume percent, by total volume of the particles, of agglomerated or single particles comprising chromia, zirconia, tantalum oxide, boron carbide, silicon carbide, titanium carbide, chromium carbide, tungsten carbide, or diamond, or combinations thereof.

In another preferred embodiment the present invention provides a nanostructured chromia matrix composite coating bonded directly on a substrate. The coating can have a thickness of up to 500 microns, or be ground and polished to 100 to 200 microns. The coating may, at least in preferred embodiments, include a reinforcing portion of a second phase material. Preferably, the coating includes from 5 to 49 volume percent of a material and comprises chromia, zirconia, tantalum oxide, boron carbide, silicon carbide, titanium carbide, chromium carbide, tungsten carbide, or diamond, or combinations thereof. In a preferred embodiment, the nanostructured chromia matrix composite coating has a ground and polished surface.

Other preferred embodiments of the invention provide for a method for applying a nanostructured chromia matrix composite coating. The method preferably includes the steps of: (a) preparing agglomerates comprising a mixture of nano-particles and nano- and/or micro-sized second-phase particles that are immiscible with chromia and corrosion resistant; (b) thermally spraying the blend of agglomerates and reinforcement particles onto a substrate surface to deposit a coating of nanostructured chromia matrix composite thereon; and (c) optionally grinding and polishing the coating. The substrate is preferably titanium or duplex stainless steel. Preferably, the mixture can include from 5 to 49 volume percent, by total volume of the particles, of nano- and/or micro-sized second-phase particles comprising chromia, zirconia, tantalum oxide, boron carbide, silicon carbide, titanium carbide, chromium carbide, tungsten carbide, or diamond, or combinations thereof.

Also disclosed herein are enhancements of valve reliability and life by the incorporation of a new type of coating material and structure (nanostructured). The fundamental principal behind the coating originates from the enhanced properties of nanostructured materials such as superior wear resistance and toughness. The nanostructured coatings are applied onto the valve components (i.e., balls and seats) via a thermal spray process. The feedstock powder used in the thermal spray process is composed of a chromium oxide composite material that meets the protective requirements against the wear and corrosion of the valve service. The thermal spray process will likely be, but is not limited to, either a plasma spray or high-velocity combustion process. Through their enhanced properties, the new coatings provide superior reliability and extended life to the valves.

Related embodiments of the invention provide for a ball valve for handling corrosive fluids and/or abrasive solid particles for example in a pressure leaching process. The ball valve may include a valve body, a ball centrally positioned in the valve body and having a central passage rotatable in the valve body between open and closed positions, and at least one seat disposed between the ball and the valve body. The ball and seat may each comprise a titanium or duplex stainless steel substrate and a nanostructured chromia matrix composite coating. The coating can have a chromia phase and a phase immiscible with the chromia phase in a proportion effective to provide enhanced mechanical properties, without compromising on corrosion resistance. The immiscible reinforcement phase preferably comprises from 5 to 49 percent by volume of the coating. The immiscible phase preferably can comprise chromia, zirconia, tantalum oxide, boron carbide, silicon carbide, titanium carbide, chromium carbide, tungsten carbide, or diamond, or combinations thereof. The coating can have a ground and polished surface. The coating can preferably have a thickness from 100 to 500 microns, or preferably when it has a ground and polished surface, a thickness of from 100 to 300 microns. The chromia preferably has a grain size less than 100 nm. The coating is preferably deposited by thermal spray application of a powder comprising a blend of spherical or substantially spherical agglomerates and spherical agglomerates and/or angular particles in a size range of from 5 to 45 microns.

A still further aspect of the invention is a pressure acid leaching process comprising alternately opening the ball valve just described to allow passage of an acid leach mixture comprising abrasive particles and closing the ball valve to stop said passage, wherein the ball and seat are substantially protected from wear by the chromia matrix composite coating.

In still further preferred embodiments of the invention there is provided an apparatus for applying a nanostructured chromia matrix composite coating to a substrate. The apparatus may include means for preparing agglomerates comprising a mixture of nanostructured chromia blended with reinforcing particles, a reservoir comprising a charge of the blended powder, and means for thermally spraying the blended powder from the reservoir onto a substrate surface to deposit a coating of nanostructured chromia matrix composite thereon.

The coatings of the present invention, in most preferred embodiments, are particularly suited for critical ball valve components, such as balls and seats. These benefit from the application of nanostructured ceramic matrix composite coatings according to the present invention. For such applications, the coating compositions preferably comprise of chromium oxide (Cr₂O₃), but can include other chemically stable compounds that form a second reinforcement phase. These second phase compounds are generally immiscible with the chromium oxide and must be resistant to corrosion, e.g., in the nickel-cobalt high pressure acid leach (NiHPAL) process. As used herein, the expression “corrosion resistant” means that the material has corrosion resistance at least similar to that of chromium oxide in NiHPAL service, e.g. 30 weight percent laterite ore in 98 weight percent sulfuric acid at over 250° C. and 4000 kPa. The chromium oxide component typically needs to maintain a grain size of 100 nm or less. Exemplary second-phase compounds include, but are not limited to, chromium oxide (Cr₂O₃), zirconium oxide (ZrO₂), tantalum oxide (Ta₂O₅), boron carbide (B₄C), silicon carbide (SiC), titanium carbide (TiC), diamond, combinations thereof, and the like. The relative quantities of the second phase preferably range from 5 vol % to 49 vol %, e.g., TiO₂-20Ta₂O₅ and TiO₂-45ZrO₂.

An important aspect in selecting coating compositions relates to the fact that having a composite material consisting of one or more, well-distributed, and immiscible particles in a matrix of fine chromium oxide matrix can substantially enhance the mechanical properties and provide thermal stability (by grain boundary pinning) of the coating. Since thermal spray application of ceramic coatings relies on heating the particles to molten or semi-molten states, mitigation of grain growth, via the thermal stability, to maintain a fine-grained coating is of importance. Also, some wear applications may involve a certain degree of exposure to elevated temperatures after the coated ball valve surfaces are placed in industrial use; if the coating does not possess a means of stabilizing the ultrafine grain structure, the associated grain growth could change the coating properties.

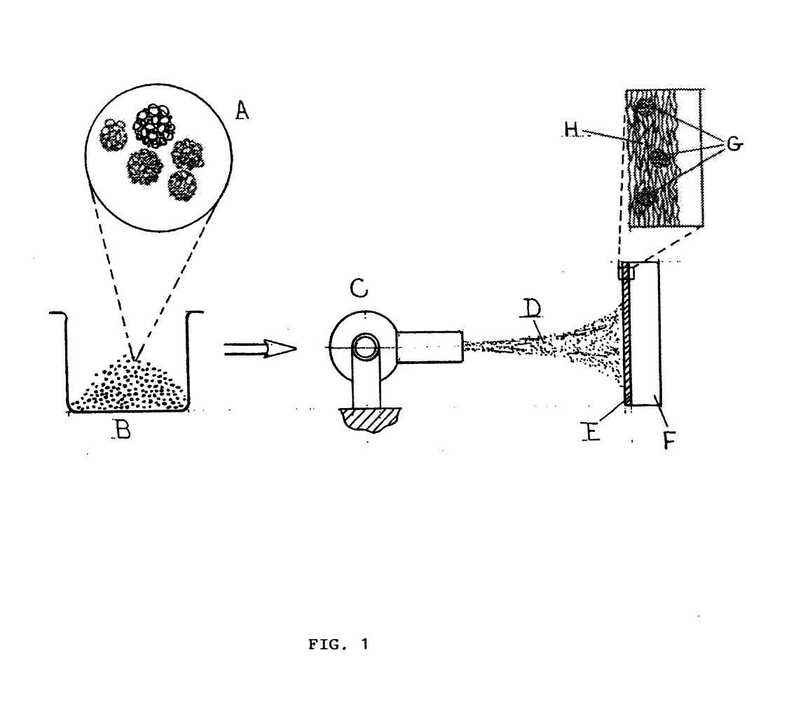

Reference is now made to FIG. 1. The agglomerated nanostructured composite powder B for thermal spray application can be produced by well-known methods for producing agglomerates of fine particles. For example, a method that is particularly well suited for the present invention includes the following steps: (1) attaining nanoparticles of Cr₂O₃ powder near or below 100 nm size range; (2) spray drying with appropriate binders to form at least substantially spherical agglomerate powder; and in some cases, (3) pressureless sintering. The final sprayable powder B consists primarily of at least substantially spherical agglomerates A, in the size range of 5 to 100 μm, preferably 10 to 45 μm, depending on the type of thermal spray process to be used, and blended with the reinforced particles in agglomerate or non-agglomerated form in the size range of 5 to 100 μm, preferably 5 to 45 μm.

The surface of the titanium or duplex stainless steel substrate is preferably pretreated for deposition of the nanostructured chromia matrix composite coating by precision roughening to 2-13 microns. This can be achieved, for example, by impacting the substrate surface with aluminum oxide or other abrasive particles using conventional sand blasting equipment, followed by cleaning the surface with a solvent and a brush to remove as many of the residual abrasive particles as possible. The alumina particles preferably have a size in the range of 20 to 36 microns. Optionally, the pretreated surface can be dried by heating to above 100° C.

To deposit a coating E on a substrate F, the blended powder B may be fed, via conventional thermal spray powder feeders, into the hot-section D of the plasma jet or combustion flame from a commercially available thermal spray torch C, where the blended particles A are heated and accelerated towards the component surface. Due to the high melting temperatures of the ceramic powders, thermal spray processes with relatively high thermal output, i.e., commercially available plasma spray and higher-temperature combustion spray systems are preferably used to apply the coatings, including a technique selected from but not limited to: flame spraying, atmospheric plasma spraying, controlled atmosphere plasma spraying, arc spraying, detonation or D-gun spraying, high velocity oxyfuel spraying, vacuum plasma spraying, and the like. The particles can experience some grain growth during deposition; however, the final coating matrix grain size should, at least in preferred embodiments, remain below 100 nm due to the grain boundary pinning.

In a preferred embodiment, the thermal spray process comprises the atmospheric plasma spray (APS) process. In the APS process, a jet of gas is heated by an electric arc to form a plasma jet. Powder feedstock is injected into the plasma jet to heat the particles and to accelerate them towards a substrate to form a coating. The spray parameters preferably include a gun current of 400-500 amps, a primary gas (argon or nitrogen) flow rate of 36-48 SLPM, a secondary (hydrogen) gas flow rate of 7-12 SLPM, a spray distance of 50-80 mm, a powder feed rate of 36-60 g/min, a maximum substrate surface temperature of 200° C., and a spray thickness of 125-500 microns. The coated substrate is then allowed to cool to ambient temperature.

Numerous deposition passes of the impinging particles are normally required to build up the coating E. The coating E is characterized by lamellae H, also known as splats, that form when substantially molten particles impinge on the substrate surface. The coating E also includes non-molten particles G, which can also include partially molten particles. These non- and/or partially-molten particles are collectively referred to herein as non-molten particles. The coating E can also include other features such as microcracks and porosity, but in selected embodiments it may be preferable to try to minimize the density of through-microcracks and through-porosity. Typical coating E thicknesses of 125 to 500 microns are deposited, followed by post-spray processing, such as, for example, conventional grinding and polishing to a mirror-like smoothness of 8 RMS or better. The final coating thickness is preferably 100 to 300 microns.

The nanostructured coating of the invention, at least in preferred embodiments, provides enhanced wear-resistance and toughness, as well as superior bond strength to the substrate. Corrosion may also be minimized by a layer of titanium against the coating, which has been passivated during the coating process. If desired, an organic or inorganic sealant can also be applied to penetrate the coating and seal any through-micro-cracks and through-porosity. For example, a viscous fluoropolymer can be used to impregnate the coating. The application of vacuum can facilitate through penetration of the fluoropolymer into the coating. These enhanced coating properties can lead to the processing of more reliable and longer lasting coated compoments.

For example, combined with sound ball-valve design, the coating of the valve components can generate very desirable results, as will be apparent from the following examples. These are presented for illustrative purposes only. The coatings of the present invention may be applied to any components (other than ball valves) in need of improved resistance for example to abrasion and/or corrosion.

### EXAMPLE 1

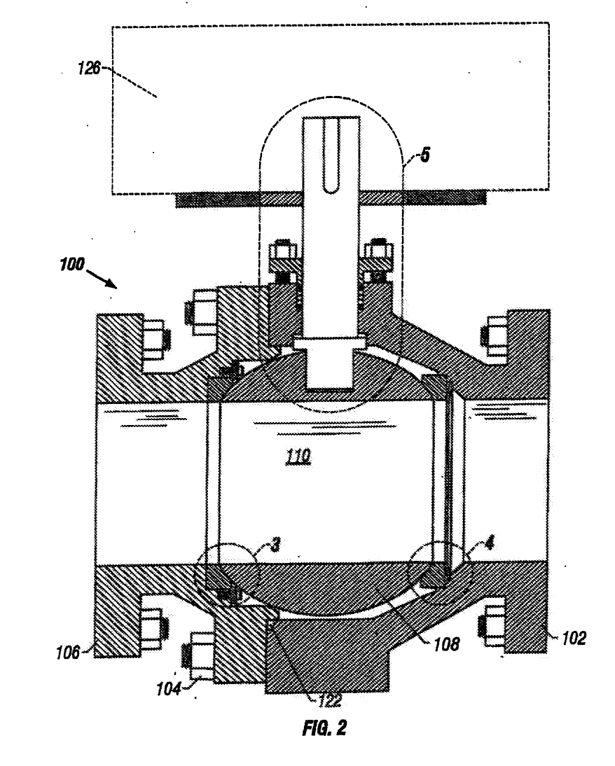

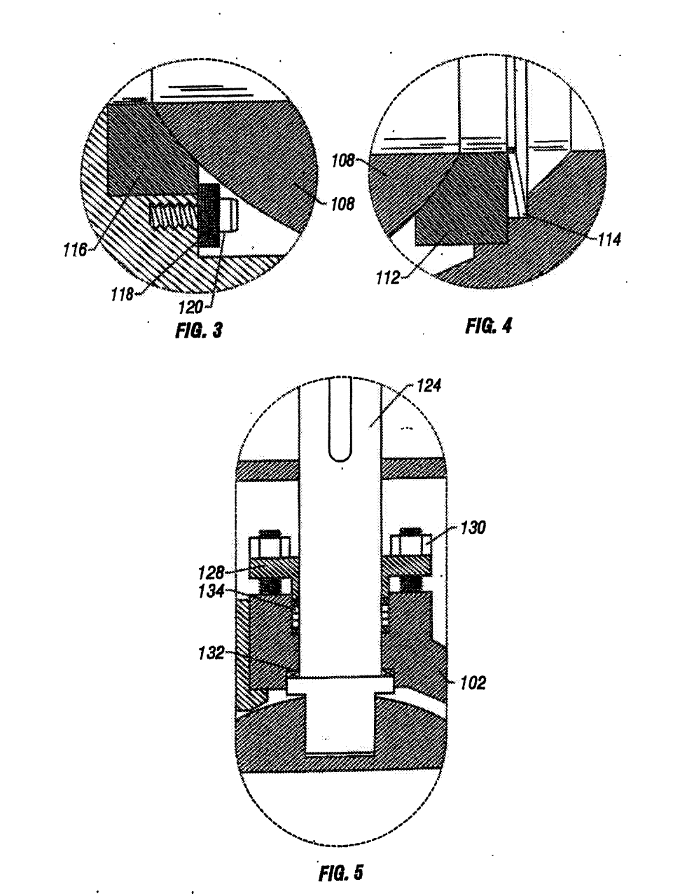

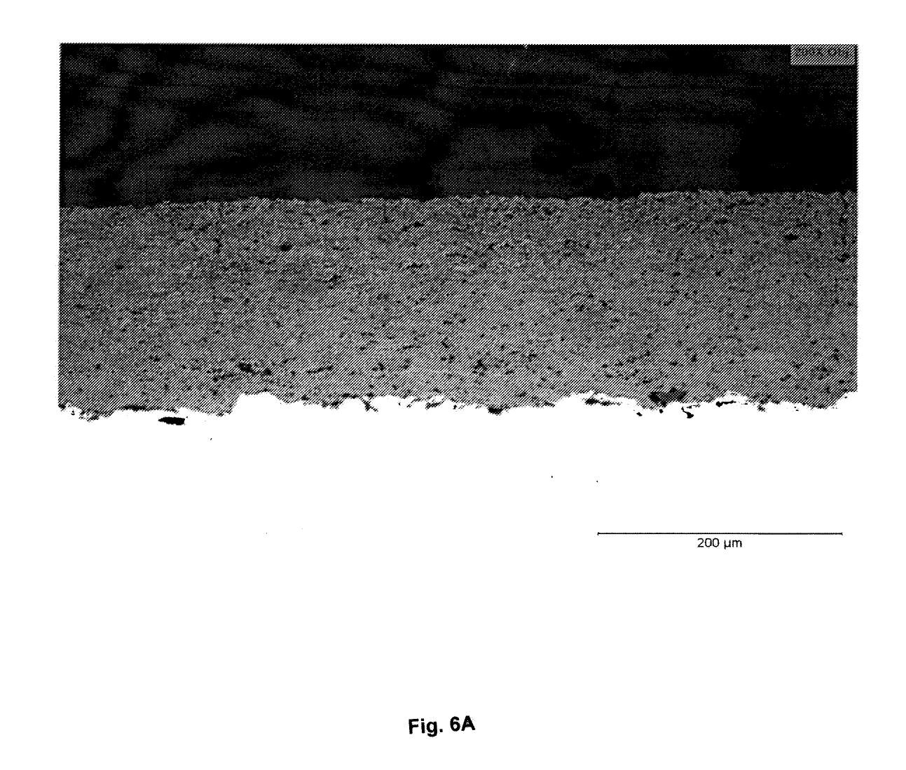

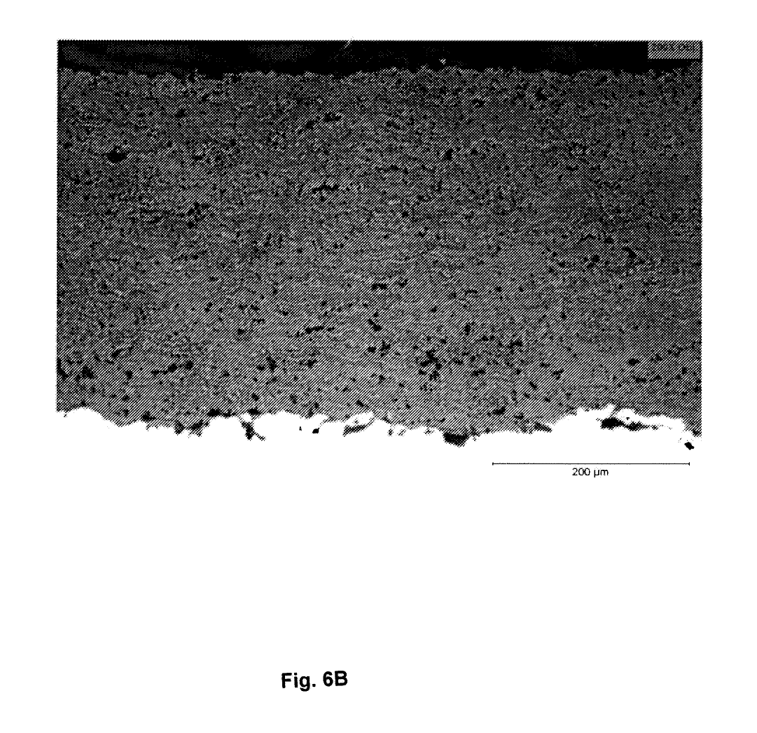

A titanium ball valve 100 according to one embodiment of this invention is pictured in FIGS. 2-5. The ball valve 100 has a titanium body 102 bolted at 104 to titanium end connector 106 to house nanostructured chromia-coated titanium ball 108, which has a central bore 110. Nanostructured chromia-coated titanium inner annular seat 112 is biased by spring 114. Nanostructured chromia-coated titanium outer annular seat 116 is held in position by seat locking ring 118 and screws 120. A gasket 122 provides a seal between the body 102 and the end connector 106, and can be made of a suitable material such as a spiral wound GRAFOIL Casketing. Stem 124 is connected to the ball 108 at one end and a conventional actuator 126 at the other. A packing gland 128 is bolted at 130 to the body 102 around the stem 124. An inner stem seal 132 is made offs conventionally titanium-coated gasket material’ or polytetrafluoroethylene, or the like. The primary stem seal 134 is expanded graphite, for example.

In the ball valve 100, the titanium parts are generally Grade 12. The stem 124 and spring 114 can be made from Grade titanium, which provides approximately two times the strength of Grade 12 and allows the use of a smaller diameter stem 124, and hence lower operating torque. Grade 12 or 29 can be used where crevice corrosion is a concern, e.g. chloride concentrations greater than 1000 ppm. Grade 29 offers strength and high resistance to corrosion.

In operation, the ball valve 100 is a bi-directional seated floating ball valve that can be utilized in pressure leach nickel extraction service, for example. The ball valve 100 is designed for easy maintenance and maximum life under severely erosive and corrosive conditions. The ball valve 100 is typically installed as an isolation valve in spare, vent, drain, slurry inlet and discharge applications on a conventional pressure leach autoclave (not shown). The ball valve 100 is alternately opened to allow the passage of fluid and closed to prevent the passage of fluid. The fluid passing through the valve or prevented from passing through the valve can be corrosive and contain abrasive particles. The ball 108 and seats 112, 114 may be protected from corrosion and erosion by the chromia coatings described above.

A nanostructured chromia matrix composite on the titanium ball valve was made by coating the titanium alloy seats 112, 114 and ball 108 of the valve shown in FIGS. 2-5. An atmospheric plasma spray (APS) gun was used, manufactured by Sulzer Metco, model number 7M with a Sulzer Metco feeder, model number 9MP. Prior to applying the coating, the component surface was grit blasted using alumina (20-36 microns) to 2-13 microns and heated to above 100° C. The powder used was nanostructured chromia agglomerates blended with nanostructured titania agglomerates that had been prepared according to specifications (agglomerates approximately 5-45 microns, particles below 100 nm) by material suppliers. The powder was applied by repeatedly passing the flame over the parts, allowing the parts to cool slightly between passes. The gun current was 400-500 A, the primary gas (argon or nitrogen) flow rate was 36-48 SLPM, and the secondary gas (hydrogen) flow rate was 7-12 SLPM. The powder injection feed rate was 36-60 g/min, and the spraying distance was 50-80 mm. The part surface temperature was maintained below 200° C. throughout the spray process. The coated ball valve parts were ground and polished to 8 RMS.

The nanostructured coating had high hardness and showed the crack-mitigating (enhanced toughness) characteristic observed in the successful nanostructured oxide coatings.

### EXAMPLE 2

The procedure of Example 1 was repeated, except that the powder was a blend of 55 volume percent chromia nanoparticles and 45 volume percent chromia microparticles. Relative to the microstructured chromia, the coated valve parts have superior toughness and adhesion without compromising on its hardness or strength.

### EXAMPLE 3

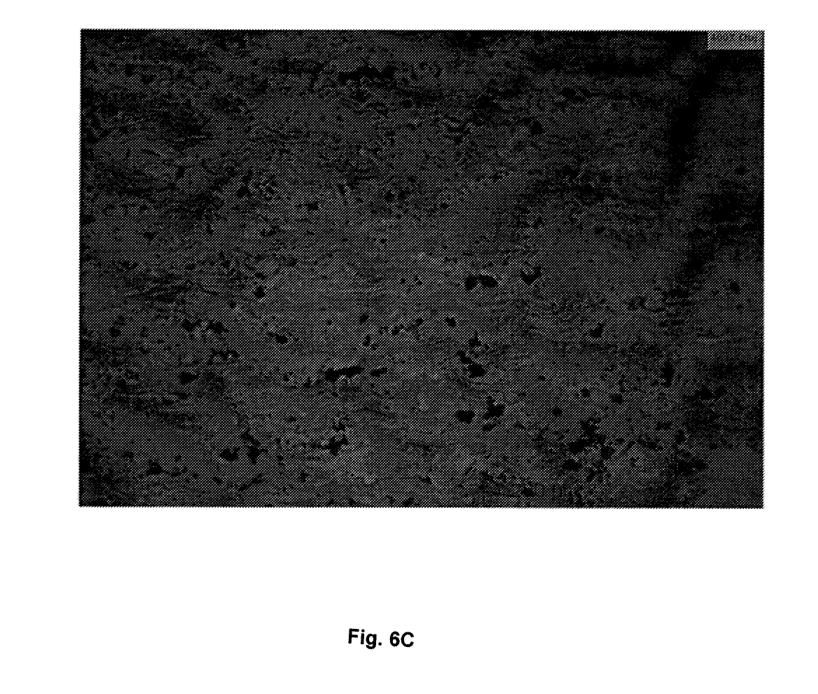

FIG. 6 illustrates electron microscope images of a sample nanostructured chromia matrix coating deposited upon a substrate by thermal spray. Corresponding data summarizing analysis of the coating is provided in Table 1 below.

The coatings exhibit the following characteristics: high hardness and high resistance to crack propagation (around the Vickers indent). These two characteristics are known to play a direct role against abrasive and erosive wear. Microhardness of the coating is reasonably anticipated to be even higher with spray parameter optimization. For example, the microhardness is likely to be greater than 1100 HV_{0.3}.

TABLE 1
Analysis and evaluation of sample 50499-10

| Item | Specifications | Results |
|---|---|---|
| Thickness | N/A | 0.015″ |
| Porosity | N/A | 4% |
| Cracks | N/A | Visible @ 200X |
| Interface | N/A | 3% |
| Inclusions | | |
| Hardness | N/A | 1138 Hv |

Whilst the invention has been described with reference to specific embodiments of methods, components, and coatings, these embodiments are in no way intended to be limiting. Further embodiments other than those actually presented are within the scope of the present invention.

### REFERENCES

1. Lawrence T. Kabacoff, “Nanoceramic Coatings Exhibit Much Higher Toughness and Wear Resistance than Conventional Coatings”, The AMPTIAC Newsletter, Spring 2002, Volume 6, Number 1.
2. M. Gell with E. H. Jordan et al., “Fabrication and Evaluation of Plasma Sprayed Nanostructured Alumina-Titania Coatings with Superior Properties,” Mater. Sci. Eng., A301, pp. 80-89, 2001.
3. M. Gell with L. Shaw et al., “Development and Implementation of Plasma Sprayed Nanostructured Ceramic Coatings, Surface and Coatings Technology,” vol. 146-147, pp. 48-54, 2001.
4. J. Williams, G. E. Kim, and J. Walker, “Ball Valves with Nanostructured Titanium Oxide Coatings for High-Pressure Acid-Leach Service: Development to Application”, Proceedings of Pressure Hydrometallury 2004, Banff, Alberta, Canada, Oct. 23-27, 2004.
5. G. E. Kim, J. Williams, J. Walker, “Nanostructured Coating Application in High-Pressure Acid-Leach Process”, Proceedings of the Nano2002 Conference, Orlando, Fla., USA, 2002.
6. G. E. Kim, “Advances in Nanostructured Thermal Spray Coatings”, Invited Speaker at ASM International's Houston Chapter Meeting, Houston, Tex., 2004.

1-3. (canceled)

4. A nanostructured chromia coating bonded directly on a titanium or duplex stainless steel substrate.

5. The coating of claim 4 having a thickness of from 250 to 500 microns.

6. The coating of claim 4 ground and polished, preferably to a thickness of from 100 to 300 microns.

7. The coating of claim 4 comprising a grain growth-inhibiting proportion of a second phase material immiscible with the chromia.

8. The coating of claim 4 comprising from 5 to 49 volume percent of a material comprising chromia, zirconia, tantalum oxide, boron carbide, silicon carbide, titanium carbide, chromium carbide, tungsten carbide, or diamond, or combinations thereof.

9-11. (canceled)

12. A ball valve for use in a pressure leaching process wherein the ball valve is exposed to corrosive fluids and/or abrasive solid particles, the ball valve comprising:
a valve body;
a ball centrally positioned in the valve body and having a central passage rotatable in the valve body between open and closed positions;
at least one seat disposed between the ball and the valve body;
wherein the ball and seat each comprise a metal substrate comprising titanium or duplex stainless steel or other metals selected for corrosion or strength, the metal substrate having a nanostructured chromia coating.

13. The ball valve of claim 12 wherein the coating comprises a chromia phase and an immiscible phase immiscible with the chromia phase in a proportion effective to inhibit grain growth and to improve wear resistance.

14. The ball valve of claim 13 wherein the immiscible phase comprises from 5 to 49 percent by volume of the coating.

15. The ball valve of claim 13 wherein the immiscible phase comprises chromia, zirconia, tantalum oxide, boron carbide, silicon carbide, titanium carbide, chromium carbide, tungsten carbide, or diamond, or combinations thereof.

16. The ball valve of claim 12 wherein the coating has a thickness of from 250 to 500 microns.

17. The ball valve of claim 12 wherein the chromia has a grain size near to or less than 100 nm.

18. The ball valve of claim 12 wherein the coating has a ground and/or polished surface.

19. The ball valve of claim 18 wherein the coating is deposited by thermal spray application of a powder comprising spherical or substantially spherical agglomerates in a size range of from 10 to 45 microns blended with agglomerated or solid particles in a size range from 10 to 45 microns.

20-22. (canceled)
